(19) United States
(12) Patent Application Publication
(10) Pub. No.: US 2026/0302512 A1
(43) Pub. Date: Oct. 1, 2026

(54) SECONDARY BATTERY AND ELECTRONIC DEVICE INCLUDING THE SECONDARY BATTERY

(71) Applicant: SAMSUNG SDI CO., LTD., Yongin-si (KR)

(72) Inventors: Jeawoan LEE, Yongin-si (KR); Won-Seok KIM, Yongin-si (KR); Soo-Mi EO, Yongin-si (KR)

(21) Appl. No.: 19/563,801

(22) Filed: Mar. 11, 2026

(30) Foreign Application Priority Data
Mar. 28, 2025 (KR) 10-2025-0040162

(51) Int. Cl. H01M 50/342; H01M 50/119

(52) U.S. Cl. CPC H01M 50/3425; H01M 50/119

(57) ABSTRACT

A secondary battery includes a case comprising a body portion having an opening formed therein and a cover covering the opening. An electrode assembly is accommodated in the case, with the electrode assembly including a first electrode, a second electrode, and a separator. At least one of the body portion and the cover includes a vent hole configured to expose a portion of the electrode assembly and a vent plate sealing the vent hole.

### CROSS-REFERENCE TO RELATED APPLICATION

This application claims priority under 35 U.S.C § 119 to Korean Patent Application No. 10-2025-0040162, filed in the Korean Intellectual Property Office on Mar. 28, 2025, the entire contents of which are hereby incorporated by reference.

### BACKGROUND

### 1. Field

The present disclosure relates to a secondary battery and an electrical device using the secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In a conventional pouch-type secondary battery, the case is formed of a material in which a thin metal film is laminated between polymer layers. After the pouch-type secondary battery is mounted in an electronic device, problems such as deformation of the case may occur during replacement or removal of the secondary battery because of the ductility of the polymer layers. Accordingly, it is desirable to provide a new secondary battery that addresses these problems.

The above information disclosed in this Background section is for enhancement of understanding of the background of the present disclosure, and therefore, it may contain information that does not constitute related (or prior) art.

### SUMMARY

An object to be solved by the present disclosure is to provide a secondary battery and an electrical device using the secondary battery that address the above-described problems.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

In embodiments, a secondary battery includes a case comprising a body portion having an opening formed therein and a cover covering the opening, and an electrode assembly accommodated in the case, with the electrode assembly including a first electrode, a second electrode, and a separator, wherein at least one of the body portion and the cover including a vent hole configured to expose a portion of the electrode assembly, and a vent plate sealing the vent hole.

In some embodiments, the vent plate is positioned on an inner surface of at least one of the body portion and the cover.

In some embodiments, the vent plate may be positioned on an outer surface of at least one of the body portion and the cover.

In some embodiments, the vent plate may include a metal film.

In some embodiments, the metal film may include at least one of copper (Cu) and nickel (Ni).

In some embodiments, the vent plate may be welded to a surface on which the vent hole is formed.

In some embodiments, a thickness of the metal film may be 4 μm to 20 μm.

In some embodiments, the vent plate may include a polymer film.

In some embodiments, the polymer film may include at least one of polypropylene (PP), casting polypropylene (CPP), and polyethylene terephthalate (PET).

In some embodiments, the vent plate may be thermally fused to a surface on which the vent hole is formed.

In some embodiments, a thickness of the polymer film may be 6 μm to 20 μm.

In some embodiments, the vent plate may further include a metal film formed on one or both surfaces of the polymer film.

In some embodiments, the vent hole may be formed in a region adjacent to at least one corner of the body portion or the cover.

In some embodiments, the vent hole may be formed in a region of the cover facing the electrode assembly.

In some embodiments, the vent hole may include two lines that cross each other.

In some embodiments, the case may include stainless use steel (SUS).

In some embodiments, the case further may include a flange portion extending from the body portion contacting the cover, and the cover and the flange portion are welded to seal the case.

In some embodiments, an electrical device includes a housing, an operation device fixed to the housing and configured to perform a predetermined operation, and a secondary battery fixed to the housing and configured to supply power to the operation device, wherein the secondary battery includes a case comprising a body portion having an opening formed therein and a cover covering the opening, an electrode assembly accommodated in the case, the electrode assembly including a first electrode, a second electrode, and a separator, wherein at least one of the body portion and the cover includes a vent hole configured to expose a portion of the electrode assembly, and a vent plate sealing the vent hole.

In some embodiments, the vent plate may be positioned on an inner surface or an outer surface of at least one of the body portion and the cover.

In some embodiments, the case may include stainless use steel (SUS).

According to some embodiments of the present disclosure, by varying the material, thickness, and joining strength of the vent plate that seals the vent hole, it is possible to manufacture a secondary battery in which the vent plate breaks at a target internal pressure so that gas can be discharged.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a perspective view of a secondary battery according to an embodiment of the present disclosure.

FIG. 2 is an exploded perspective view of a secondary battery according to an embodiment of the present disclosure.

FIG. 3 shows an example of a vent hole and a vent plate formed in a cover of a case according to an embodiment of the present disclosure.

FIG. 4 shows another example of a vent hole and a vent plate formed in a cover of a case according to an embodiment of the present disclosure.

FIG. 5 shows an example of a vent hole and a vent plate formed in a body portion of a case according to an embodiment of the present disclosure.

FIG. 6 shows another example of a vent hole and a vent plate formed in a body portion of a case according to an embodiment of the present disclosure.

FIG. 7 shows an example in which a vent plate is attached to an inner surface of a case according to an embodiment of the present disclosure.

FIG. 8 shows an example in which a vent plate is attached to an outer surface of a case according to an embodiment of the present disclosure.

FIGS. 9 to 13 illustrate vent holes having various shapes according to embodiments of the present disclosure.

FIGS. 14 and 15 illustrates an electrical device using the secondary battery according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In a secondary battery that includes a metallic case containing stainless use steel (SUS) or stainless steel, when an abnormal event (such as overcharging, long-term exposure to a high temperature, or heat generation caused by an internal short) occurs, gas may be generated inside the secondary battery. Because of this gas generation, the secondary battery may be at risk of explosion. Thus, a vent for discharging the gas is required.

The vent may be formed by etching a portion of the case to a thin thickness so that when the internal pressure increases the etched portion breaks open and the gas is discharged. However, manufacturing process may not form this type of vent uniformly. As a result, vents of this type may sometimes fail to break open at the designed internal pressure.

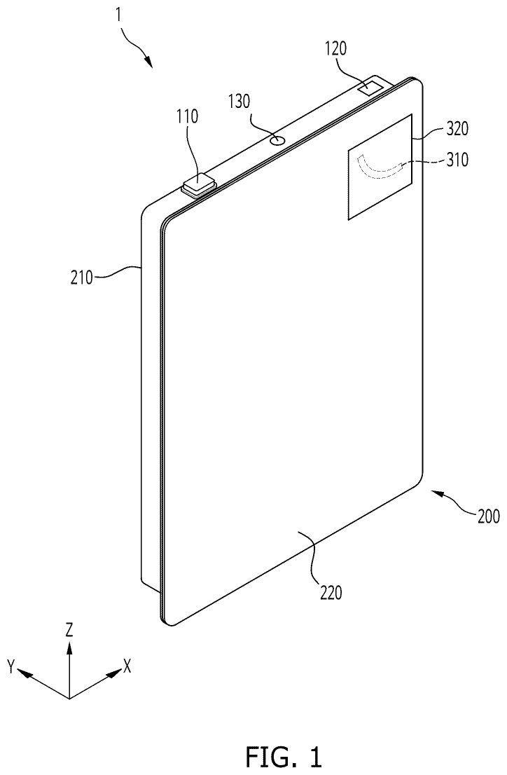

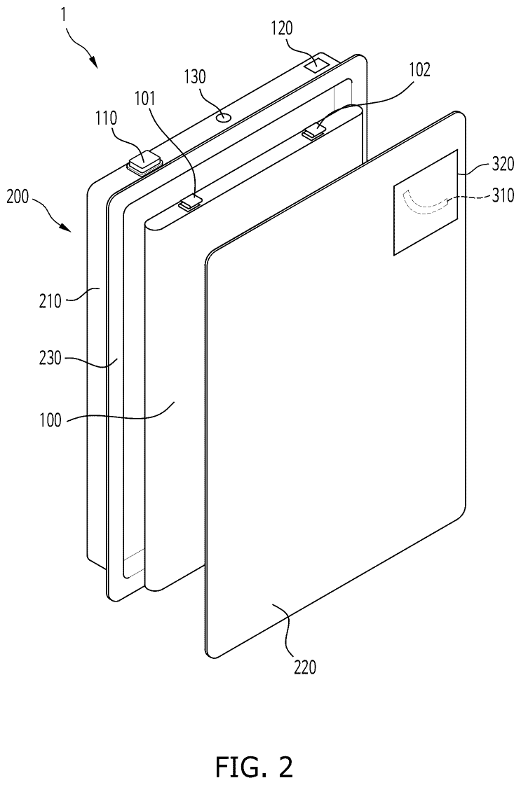

FIG. 1 is a perspective view of a secondary battery according to an embodiment of the present disclosure. FIG. 2 is an exploded perspective view of the secondary battery according to an embodiment of the present disclosure.

Referring to FIGS. 1 and 2, a secondary battery 1 according to an embodiment of the present disclosure may include an electrode assembly 100 and a case 200. The electrode assembly 100 may include a first electrode, a second electrode, and a separator. For example, the first electrode may be a positive electrode, and the second electrode may be a negative electrode. For example, the electrode assembly 100 may be a wound-type electrode assembly formed by winding the first electrode and the second electrode with the separator, which is an insulator, interposed between the first and second electrodes. In another example, the electrode assembly 100 may be a stacked-type electrode assembly in which the first electrode and the second electrode are alternately stacked with the separator interposed therebetween or may be any structure that includes the first electrode and the second electrode. The structures of the electrode assembly 100 described herein are only examples, and the present disclosure is not limited to these examples.

The first electrode may include a coating portion where an active material is applied on opposite surfaces of a first substrate formed of a thin metal plate, and a non-coating portion where the active material is not provided and the substrate is exposed. The first electrode may include non-coating portions at the side edges of the first substrate in the winding direction. The first electrode may be formed by coating a positive active material such as a transition-metal oxide on a metal substrate such as aluminum or an aluminum alloy.

The second electrode may include a coating portion where an active material is applied on opposite surfaces of a second substrate formed of a thin metal plate, and a non-coating portion where the active material is not provided and the substrate is exposed. The second electrode may include non-coating portions at the side edges of the second substrate in the winding direction. The second electrode may be formed by coating a negative active material such as graphite or carbon on a metal substrate such as copper, a copper alloy, nickel, or a nickel alloy.

The separator may be positioned between the first electrode and the second electrode. The separator may insulate the first electrode from the second electrode from each other and may allow lithium ions to be exchanged between the first electrode and the second electrode. The separator may have a sufficient length to completely insulate between the first electrode and the second electrode even if the electrode assembly 100 shrinks or expands during charging and discharging of the secondary battery 1.

The electrode assembly 100 may further include a first electrode tab 101 and a second electrode tab 102. The first electrode tab 101 may be separately formed and connected to a non-coating portion of the first electrode, or may be formed by punching a part of the non-coating portion. The first electrode tab 101 may extend from the non-coating portion and contact a first electrode terminal 110. The first electrode tab 101 may form a current path between the first electrode and the first electrode terminal 110. The second electrode tab 102 may be separately formed and connected to a non-coating portion of the second electrode or may be formed by punching a part of the non-coating portion. The second electrode tab 102 may extend from the non-coating portion and contact the case 200. The second electrode tab 102 may directly contact the case 200 or may contact a negative-electrode terminal provided on an inner surface of the case 200. In another example, the negative-electrode terminal may be provided on an outer surface of the case 200. The second electrode tab 102 may form a current path between the second electrode and the case 200.

The case 200 may form an overall exterior of the secondary battery 1. The case 200 may be formed from stainless use steel (SUS) or stainless steel. In other embodiments, the case 200 may be formed from a conductive metal such as aluminum, an aluminum alloy, or nickel-plated steel. The thickness of the case 200 may be 0.05 mm to 0.5 mm, but the present disclosure is not limited to these examples.

The case 200 may include a body portion 210 having an opening and be configured to accommodate the electrode assembly 100. A cover 220 may be provided to cover opening in the body portion 210 and thereby seal the electrode assembly 100 in the case 200. The case 200 may further include a flange portion 230 extending from the body portion 210 and configured to contact the cover 220.

The body portion 210 may have an internal space formed with a step relative to the flange portion 230 and may accommodate the electrode assembly 100 in the internal space. For example, the body portion 210 may have an internal space with dimensions larger than those of the electrode assembly 100 and may accommodate the electrode assembly 100 and an electrolyte.

The cover 220 may be configured to cover the opening in the body portion 210 and seal the electrode assembly 100. For example, with the electrode assembly 100 accommodated in the body portion 210, the cover 220 may cover the opening in the body portion 210 and may be joined to the flange portion 230 by welding the cover 220 and the flange portion 230 together. the flange portion 230 may extend from the body portion 210 and may be configured to contact the cover 220. In particular, the flange portion 230 may be provided along an edge of the body portion 210. With the electrode assembly 100 accommodated in the body portion 210, the flange portion 230 may be joined to the cover 220. together, for example, by welding.

Although an embodiment has been described with reference to the configuration including the flange portion 230, the present disclosure is not limited to such a configuration. In other embodiments, the cover 220 and the body portion 210 may be joined without the flange portion 230. In one example, the cover 220 and the body portion 210 may be welded together.

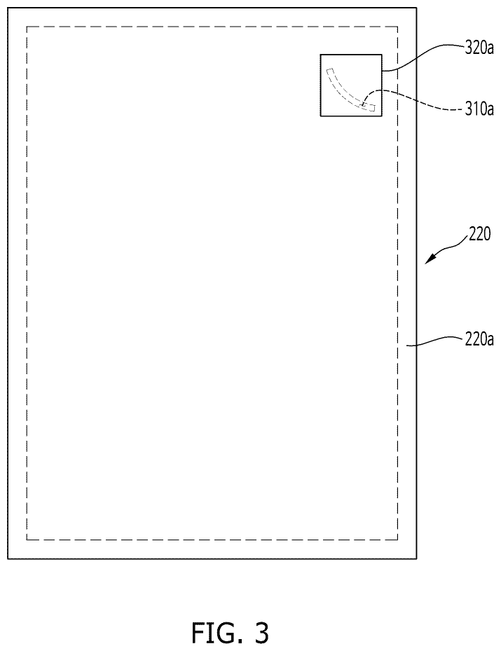

At least one of the body portion 210 and the cover 220 may include a vent hole 310 configured to expose a portion of the electrode assembly 100. A vent plate 320 may be provided that is configured to seal the vent hole 310. During an abnormal event, the internal pressure of the secondary battery 1 may increase. When the internal pressure of the secondary battery 1 becomes a predetermined pressure or higher, the vent plate 320 may rupture. The gas inside the secondary battery 1 may then be discharged through the vent hole 310, thereby preventing the secondary battery 1 from exploding. Details of the vent hole 310 and the vent plate 320 will be described below with reference to FIGS. 3-6.

On a side surface of the case 200, the first electrode terminal 110, the second electrode terminal 120, and an electrolyte inlet 130 may be formed. However, in other embodiments, the sides where the first electrode terminal 110, the second electrode terminal 120, and the electrolyte inlet 130 are formed may differ.

The first electrode terminal 110 may extend through a side surface of the case 200. An insulating gasket (not shown) may be interposed between the first electrode terminal 110 and the case 200 such that the first electrode terminal 110 is insulated from the case 200 by the insulating gasket. The first electrode terminal 110 may be electrically connected to the first electrode of the electrode assembly 100 by the first electrode tab 10. Thus, the first electrode terminal 110 may function as the positive terminal.

The second electrode terminal 120 may be provided on a side surface of the case 200. The second electrode terminal 120 may be spaced apart from the first electrode terminal 110, and the second electrode terminal 120 may be electrically connected to the case 200. In particular, the second electrode terminal 120 may contact the case 200. Because the case 200 may suffer damage during a process of being welded to an external component, the second electrode terminal 120, which has high welding strength, may be attached to the case 200. In an example, the second electrode terminal 120 may be formed of a metal film having excellent welding strength and higher electrical conductivity than the case 200.

The second electrode terminal 120 may be electrically connected to the second electrode of the electrode assembly 100. The case 200 may be electrically connected to the second electrode by the second electrode tab 102. The case 200 and the second electrode terminal 120 are connected electrically to the second electrode to thereby function as the negative terminal.

The electrolyte inlet 130 may be formed in a side surface of the case 200. The electrolyte inlet 130 may be formed between the first electrode terminal 110 and the second electrode terminal 120. But the present disclosure is not limited to this configuration and may be formed in any region on one side surface or on another side surface. After electrolyte is injected, the electrolyte inlet 130 may be sealed by a sealing member.

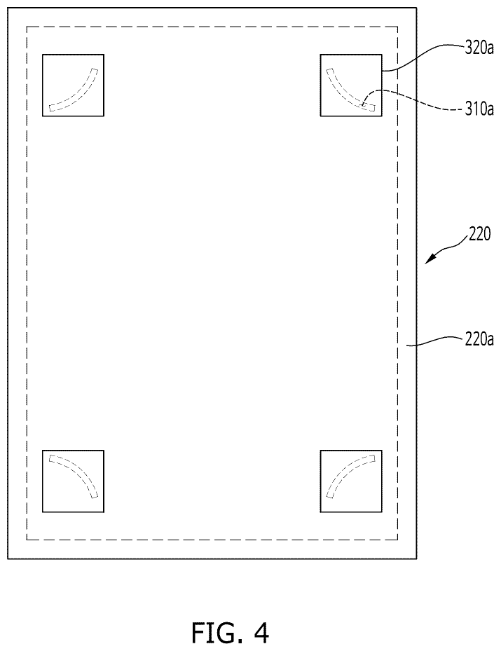

FIG. 3 illustrates an example of the vent hole and the vent plate formed in the cover of the case according to an embodiment of the present disclosure. FIG. 4 illustrates another example of the vent hole and the vent plate formed in the cover of the case according to an embodiment of the present disclosure.

Referring to FIG. 3, a vent hole 310a may be formed in the cover 220 of the case according to an embodiment. The vent hole 310a may be formed in a region of the cover 220 that faces the electrode assembly 100 (see FIG. 2). As described above, along the periphery of the cover 220, a portion 220a may be welded to the flange portion 230 (see FIG. 2). The vent hole 310a may be formed inside the portion 220a of the cover 220 that contacts the flange portion 230. The vent plate 320a may be disposed on the surface of the cover 220 over the vent hole 310a.

Referring to FIG. 4, a plurality of vent holes 310a may be formed in regions adjacent to corners of the cover 220. For example, at least one vent hole 310a may be formed between a central region of the cover 220 and each corner of the cover 220, but the present disclosure is not limited to such a configuration. The vent plate 320a may be disposed on one surface of the cover 220 so as to seal each of the vent holes 310a that are formed in the regions adjacent to the corners.

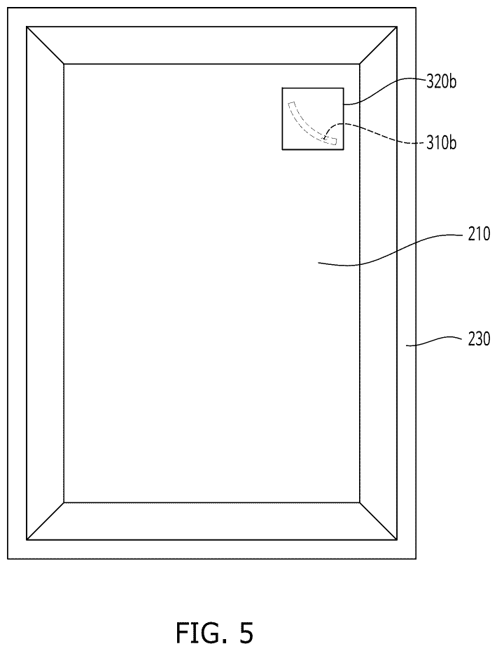

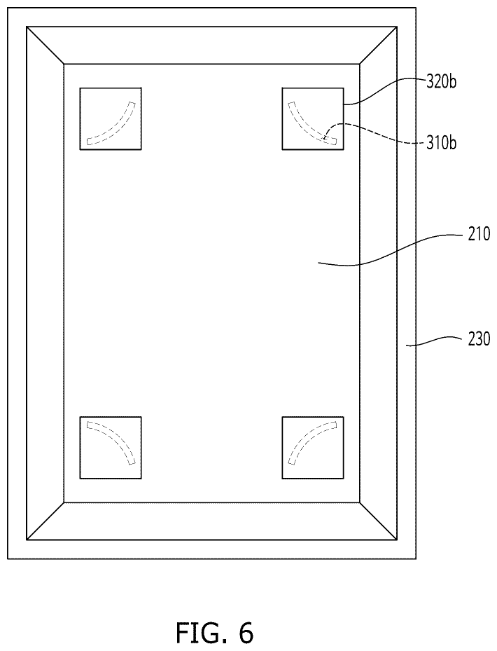

FIG. 5 illustrates an example of the vent hole and the vent plate formed in the body portion of the case according to an embodiment of the present disclosure. FIG. 6 illustrates another example of the vent hole and the vent plate formed in the body portion of the case according to an embodiment of the present disclosure.

Referring to FIG. 5, a vent hole 310b may be formed in the body portion 210 of the case. The vent hole 310b may be formed in a region of the body portion 210 that faces the electrode assembly 100 (see FIG. 2). For example, the vent hole 310b may be formed in a surface of an internal space that accommodates the electrode assembly 100 and has a step with respect to the flange portion 230. The vent plate 320b may be disposed on the surface of the body portion 210 over the vent hole 310b.

The vent hole 310b may be formed in a side surface of the body portion 210. Although not shown in FIG. 5, for example, the vent hole 310b may be formed in the side surface where the first electrode terminal 110 (see FIG. 2) and the second electrode terminal 120 (see FIG. 2) are provided. But the present disclosure is not limited thereto and the vent hole 310b may be formed in another side surface of the body portion 210.

Referring to FIG. 6, a plurality of vent holes 310b may be formed in regions adjacent to corners of the body portion 210. For example, at least one vent hole 310b may be formed between a central region of the body portion 210 and each corner of the body portion 210, but the present disclosure is not limited thereto. The vent plate 320b may be disposed on the surface of the body portion 210 to seal each of the vent holes 310b that are formed in the regions adjacent to the corners.

Although not shown in FIG. 6, at least one vent hole 310b may be formed in a side surface adjacent to each corner of a rear surface of the body portion 210. For example, vent hole(s) 310b may be formed in a broad surface facing the electrode assembly 100 (see FIG. 2).

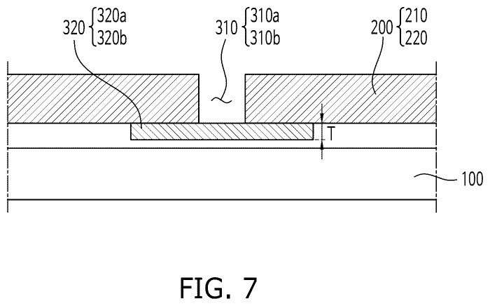

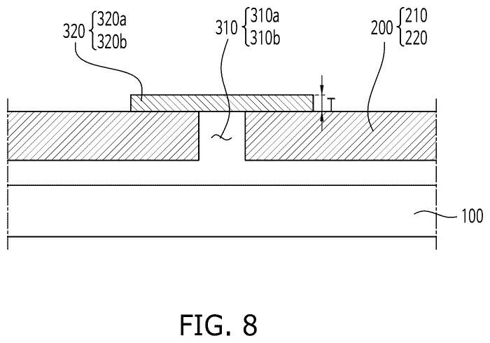

FIG. 7 illustrates an example in which a vent plate is attached to an inner surface of the case according to an embodiment of the present disclosure. FIG. 8 illustrates an example in which a vent plate is attached to an outer surface of the case according to an embodiment of the present disclosure.

Referring to FIG. 7, the vent hole 310 may be formed in at least one of the body portion 210 and the cover 220 of the case 200. The vent plate 320 may be disposed over the vent hole 310 so as to seal the vent hole 310. The vent plate 320 may be disposed on an inner surface of at least one of the body portion 210 and the cover 220. Here, the inner surface refers to a surface of the case 200 that faces the electrode assembly 100.

The vent plate 320 may be a single-layer structure or a multilayer structure. The vent plate 320 may include a metal film (or a thin metal film). In an embodiment, the metal film may include at least one of copper (Cu) and nickel (Ni), but the present disclosure is not limited to these examples. The metal film may have a thickness T of, for example, 4 μm to 20 μm. As such, the thickness T of the metal film may be thinner than the thickness of the case. The vent plate 320 including the metal film may be welded to the inner surface of the case 200 in which the vent hole 310 is formed.

The vent plate 320 may include a polymer film. The polymer film may include at least one of polypropylene (PP), casting polypropylene (CPP), and polyethylene terephthalate (PET), but the present disclosure is not limited to these examples. The polymer film may have a thickness T of, for example 6 μm to 20 μm. The vent plate 320 including the polymer film may be thermally fused to the inner surface of the case 200 in which the vent hole 310 is formed.

The vent plate 320 may further include the metal film(s) formed on one surface or both surfaces of the polymer film.

Referring to FIG. 8, the vent plate 320 may be disposed over the vent hole 310 so as to seal the vent hole 310. Specifically, the vent plate 320 may be disposed on an outer surface of at least one of the body portion 210 and the cover 220. Here, the outer surface refers to an external surface of the case 200. The vent plate 320 may be as described above with reference to FIG. 7.

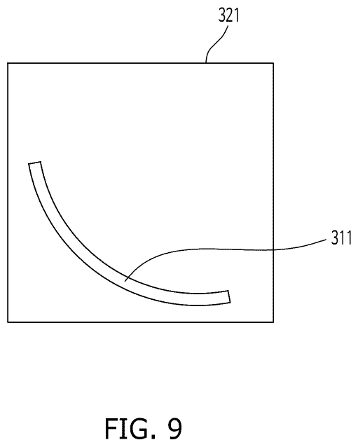

FIGS. 9 to 13 illustrate vent holes of various shapes according to embodiments of the present disclosure.

Referring to FIGS. 9 to 13, vent holes 311, 312, 313, 314, 315 having various shapes according to embodiments of the present disclosure may be formed in at least one of the body portion 210 and the cover 220 of the case 200 (see FIG. 2). Vent plates 321, 322, 323, 324, 325 may be disposed over the respective vent holes 311, 312, 313, 314, 315.

As shown in FIG. 9, the vent hole 311 may include a vent line having a curved shape. For example, the vent hole 311 may be an arc-shaped vent line, but the present disclosure is not limited to such a shape. Although one vent hole 311 is illustrated in FIG. 9, a plurality of vent holes 311 may be formed.

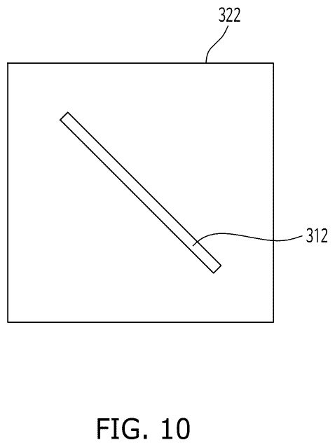

As shown in FIG. 10, the vent hole 312 may include a vent formed in a straight line. For example, the vent hole 312 may include vent lines in various directions, such as a horizontal straight line, a vertical straight line, or an oblique straight line. Although one vent hole 312 is illustrated in FIG. 10, a plurality of vent holes 312 may be formed.

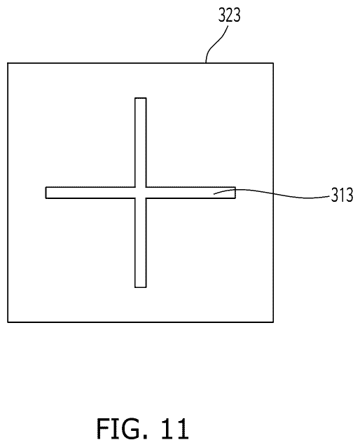

As shown in FIG. 11, the vent hole 313 may include two vent lines that cross each other. For example, the vent hole 313 may include two vent lines forming right angles, but the present disclosure is not limited thereto.

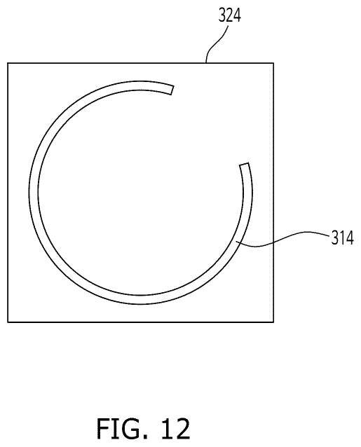

As shown in FIG. 12, the vent hole 314 may include a vent line having an opening in a circular shape. For example, the vent hole 314 may include a vent line having a C-shaped opening, but the present disclosure is not limited thereto.

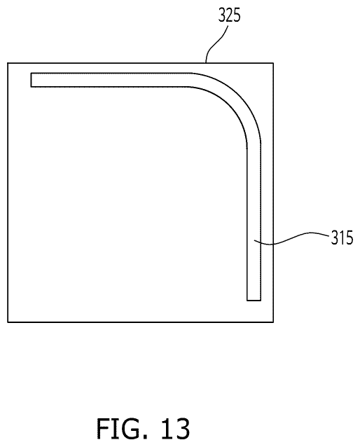

As shown in FIG. 13, the vent hole 315 may include a vent line having a straight-line shape that is bent. For example, the vent hole 315 may include a vent line having a straight-line shape that is bent adjacent to a periphery of the vent plate 325, but the present disclosure is not limited thereto.

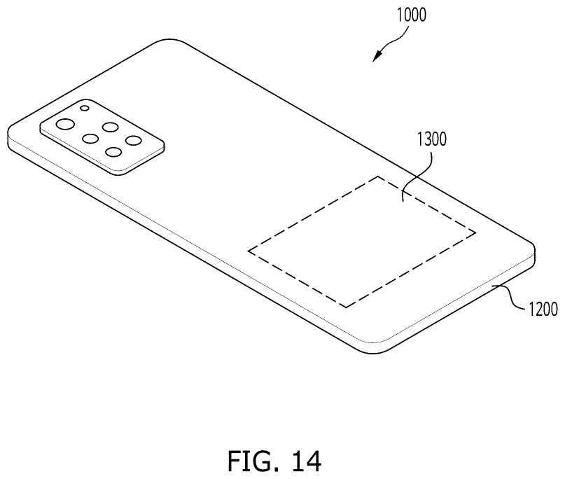

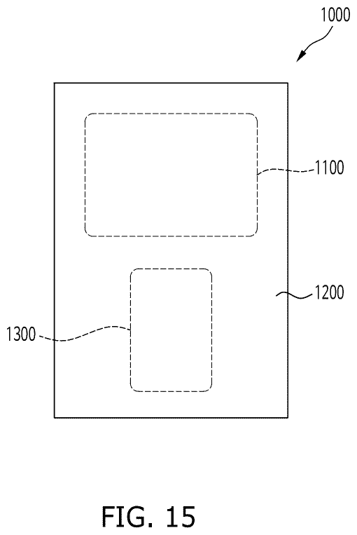

FIGS. 14 and 15 illustrate an electrical device using the secondary battery according to an embodiment of the present disclosure.

Referring to FIGS. 14 and 15, an electrical device 1000 may include an operation device 1100 configured to perform a predetermined operation, a housing 1200 in which the operation device is accommodated, and a secondary battery 1300 fixed inside the housing 1200 and configured to supply power to the operation device 1100.

The electrical device 1000 including the secondary battery 1300 may be, for example, a smart phone. But the present disclosure is not limited to such a device, and may be applied to various devices that use electric energy stored in the secondary battery 1300 and require a protection circuit.

The operation device 1100 may include various hardware devices driven by electric energy supplied from the secondary battery 1300. For example, the operation device 1100 may include an application processor (AP) or a central processing unit (CPU) of a portable electronic device.

A printed circuit board (not shown) having signal transmission wirings may be disposed inside the housing 1200. The operation device 1100 may be mounted on the printed circuit board and electrically connected to other components of the electrical device 1000.

The housing 1200 may accommodate the operation device 1100 and the secondary battery 1300 therein and may define an exterior of the electrical device 1000. The housing 1200 may be provided in various structures that support the operation device 1100 and the secondary battery 1300 arranged inside the housing 1200 and protects the operation device 1100 and the secondary battery 1300 from external impacts.

The secondary battery 1300 may be fixed inside the housing 1200 and may supply power to the operation device 1100. For example, the secondary battery 1300 may be arranged in a power-supply region inside the housing 1200 and may be connected to terminals of the printed circuit board. Accordingly, the operation device 1100 may be driven using electric energy stored in the secondary battery 1300.

The secondary battery 1300 may include the electrode assembly 100 comprising the first electrode, the second electrode, and the separator, and the case 200 configured to accommodate the electrode assembly 100. The case 200 may include the body portion 210 having an opening and be configured to accommodate the electrode assembly 100. The cover 220 may cover the opening in the body portion 210 and seal the electrode assembly 100. The flange portion 230 may extend from the body portion 210 and contact the cover 220. At least one of the body portion 210 and the cover 220 may include the vent hole 310 configured to expose/open a portion of the electrode assembly 100. The vent plate 320 may seal the vent hole 310.

The vent plate 320 may seal the vent hole 310 from an inner surface or an outer surface of at least one of the body portion 210 and the cover 220. Here, the inner surface or the outer surface may refer to the inner surface or the outer surface of the case 200.

The case 200 may be formed of stainless use steel (SUS). In other embodiments, the case 200 may be formed of a conductive metal such as aluminum, an aluminum alloy, or nickel-plated steel. The thickness of the case 200 may be 0.05 mm to 0.5 mm, but the present disclosure is not limited thereto.

Because the secondary battery 1300 has substantially the same configuration as the secondary battery 1 described with reference to FIGS. 1-13, a further description of the secondary battery 1300 will be omitted.

Although the present disclosure has been described above with respect to embodiments thereof, the present disclosure is not limited thereto. Various modifications and variations can be made thereto by those skilled in the art within the spirit of the present disclosure.

Description of Reference Symbols

1: secondary battery
100: electrode assembly
101: first electrode tab
102: second electrode tab
110: first electrode terminal
120: second electrode terminal
130: electrolyte inlet
200: case
210: body portion
220: cover
230: flange portion
310: vent hole
320: vent plate

What is claimed is:

1. A secondary battery comprising:
a case comprising a body portion having an opening formed therein and a cover covering the opening; and
an electrode assembly accommodated in the case, the electrode assembly comprising a first electrode, a second electrode, and a separator wherein at least one of the body portion and the cover comprises:
a vent hole configured to expose a portion of the electrode assembly; and
a vent plate sealing the vent hole.

2. The secondary battery as claimed in claim 1, wherein the vent plate is positioned on an inner surface of at least one of the body portion and the cover.

3. The secondary battery as claimed in claim 1, wherein the vent plate is positioned on an outer surface of at least one of the body portion and the cover.

4. The secondary battery as claimed in claim 1, wherein the vent plate comprises a metal film.

5. The secondary battery as claimed in claim 4, wherein the metal film comprises at least one of copper and nickel.

6. The secondary battery as claimed in claim 4, wherein the vent plate is welded to a surface in which the vent hole is formed.

7. The secondary battery as claimed in claim 4, wherein a thickness of the metal film is 4 μm to 20 μm.

8. The secondary battery as claimed in claim 1, wherein the vent plate comprises a polymer film.

9. The secondary battery as claimed in claim 8, wherein the polymer film comprises at least one of polypropylene, casting polypropylene, and polyethylene terephthalate.

10. The secondary battery as claimed in claim 8, wherein the vent plate is thermally fused to a surface in which the vent hole is formed.

11. The secondary battery as claimed in claim 8, wherein a thickness of the polymer film is 6 μm to 20 μm.

12. The secondary battery as claimed in claim 8, wherein the vent plate further comprises a metal film formed on one or both surfaces of the polymer film.

13. The secondary battery as claimed in claim 1, wherein the vent hole is formed in a region adjacent to at least one corner of the body portion or the cover.

14. The secondary battery as claimed in claim 1, wherein the vent hole is formed in a region of the cover facing the electrode assembly.

15. The secondary battery as claimed in claim 1, wherein the vent hole comprises two lines that cross each other.

16. The secondary battery as claimed in claim 1, wherein the case comprises stainless use steel.

17. The secondary battery as claimed in claim 1, wherein the case further comprises a flange portion extending from the body portion and contacting the cover, and
wherein the cover and the flange portion are welded to seal the case.

18. An electrical device comprising:
a housing;
an operation device fixed to the housing and configured to perform a predetermined operation;
a secondary battery fixed to the housing and configured to supply power to the operation device,
wherein the secondary battery comprises:
a case comprising a body portion having an opening formed therein and a cover covering the opening;
an electrode assembly accommodated in the case, the electrode assembly comprising a first electrode, a second electrode, and a separator; and
wherein at least one of the body portion and the cover comprises:
a vent hole configured to expose a portion of the electrode assembly; and
a vent plate sealing the vent hole.

19. The electrical device as claimed in claim 18, wherein the vent plate is positioned on an inner surface or an outer surface of at least one of the body portion and the cover.

20. The electrical device as claimed in claim 18, wherein the case comprises stainless use steel.
